(19) United States
(12) Patent Application Publication
(10) Pub. No.: US 2013/0240663 A1
(43) Pub. Date: Sep. 19, 2013

(54) UNDER SWASH LEVELING TOOL FOR RADIO CONTROLLED HELICOPTERS

(71) Applicant: Richard Lohr, Pittsfield, MA (US)

(72) Inventor: Richard Lohr, Pittsfield, MA (US)

(21) Appl. No.: 13/844,231

(22) Filed: Mar. 15, 2013

Related U.S. Application Data
(60) Provisional application No. 61/612,060, filed on Mar. 16, 2012.

(51) Int. Cl. B64C 27/605

(52) U.S. Cl. CPC B64C 27/605
USPC 244/17.25

(57) ABSTRACT

A swash leveling tool for radio controlled (RC) helicopters can fit onto the main shaft under the swash plate to provide a level reference plane. Unlike conventional swash leveling tools that require removal of the head, the swash leveling tool of the present invention provides a level reference plane for the swash without having to take the time to disassemble portions of the helicopter.

### CROSS-REFERENCE TO RELATED APPLICATION

This application claims the benefit of priority of U.S. provisional application No. 61/612,060, filed Mar. 16, 2012, the contents of which are herein incorporated by reference.

### BACKGROUND OF THE INVENTION

The present invention relates to radio controlled (RC) helicopter accessories and, more particularly, to an under swash leveling tool (USLT) for RC helicopters available for each size main shaft.

Swash leveling tools traditionally could only be used after removing the head from the helicopter, which takes time and effort.

As can be seen, there is a need for an improved swash leveling tool that may be quickly and easily used without requiring the user to remove the head from the helicopter.

### SUMMARY OF THE INVENTION

In one aspect of the present invention, a swash leveling tool comprises a member having an opening to removably retain a main shaft of a radio controlled helicopter therein; and reference plane on the member providing a surface normal to the main shaft for leveling a swash of the helicopter, wherein the member can be attached to and removed from the main shaft without removal of a head from the helicopter.

In another aspect of the present invention, a swash leveling tool comprises a member having an opening to removably retain a main shaft of a radio controlled helicopter therein; a reference plane on the member providing a surface normal to the main shaft for leveling a swash of the helicopter; and a plurality of contact points disposed about a central region of the member, wherein the main shaft snaps in place between the plurality of contact points, wherein at least one of the plurality of contact points protruding into the opening; and the member can be attached to and removed from the main shaft without removal of a head from the helicopter.

In a further aspect of the present invention, a swash leveling tool comprises a member having a central hole and for receiving a main shaft of a radio controlled helicopter therein and a slot communicating the central hole with an exterior of the member; a cover removably fitting over the slot; a reference plane on the member providing a surface normal to the main shaft for leveling a swash of the helicopter, wherein the member can be attached to and removed from the main shaft without removal of a head from the helicopter; the slot has a width equal to a diameter of the main shaft and the central hole has a diameter equal to the diameter of the main shaft; and the cover has angled sides mating with angled sides of the slot.

These and other features, aspects and advantages of the present invention will become better understood with reference to the following drawings, description and claims.

### BRIEF DESCRIPTION OF THE DRAWINGS

FIG. 1 is a front view of a swash leveling tool according to an exemplary embodiment of the present invention;

FIG. 2 is a perspective view of the swash leveling tool of FIG. 1;

FIG. 3 is a front view of swash leveling tool according to another exemplary embodiment of the present invention;

FIG. 4 is a perspective view of the swash leveling tool of FIG. 3;

FIG. 5 is a perspective view of a swash leveling tool according to an exemplary embodiment of the present invention, installed on a helicopter shaft and removed from the helicopter;

FIG. 6 is a detailed perspective view of a swash leveling tool according to an exemplary embodiment of the present invention, installed on a shaft;

FIG. 7 is a front view of a two-piece swash leveling tool according to exemplary embodiments of the present invention;

FIG. 8 is a perspective view of the two-piece swash leveling tool of FIG. 7;

FIG. 9 is a front view of the swash leveling tool of FIG. 7 in an assembled configuration; and

FIG. 10 is a perspective view of the swash leveling tool of FIG. 7 in an assembled configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a swash leveling tool for radio controlled (RC) helicopters that can fit onto the main shaft under the swash plate to provide a level reference plane. Unlike conventional swash leveling tools that require removal of the head, the swash leveling tool of the present invention provides a level reference plane for the swash without having to take the time to disassemble portions of the helicopter.

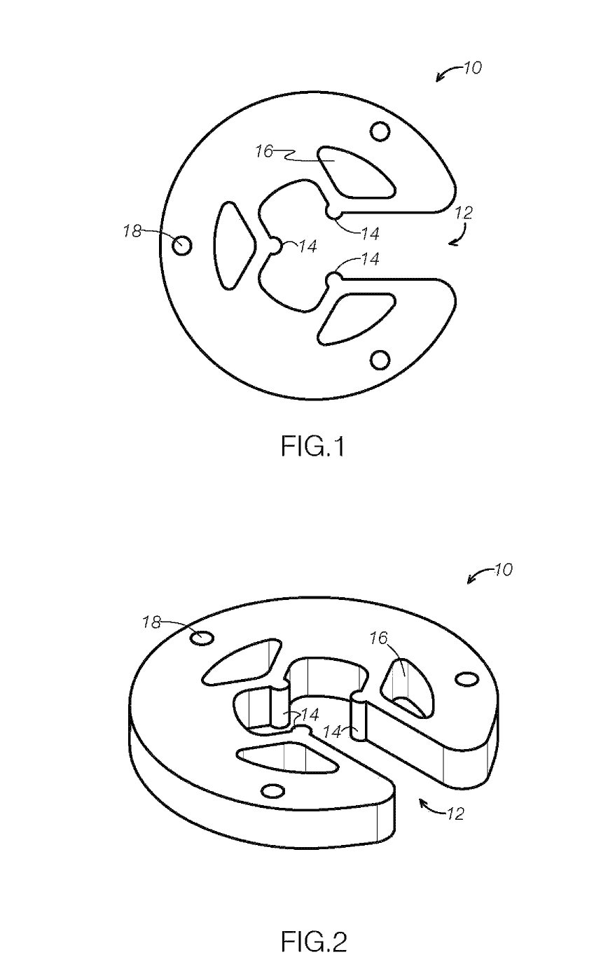

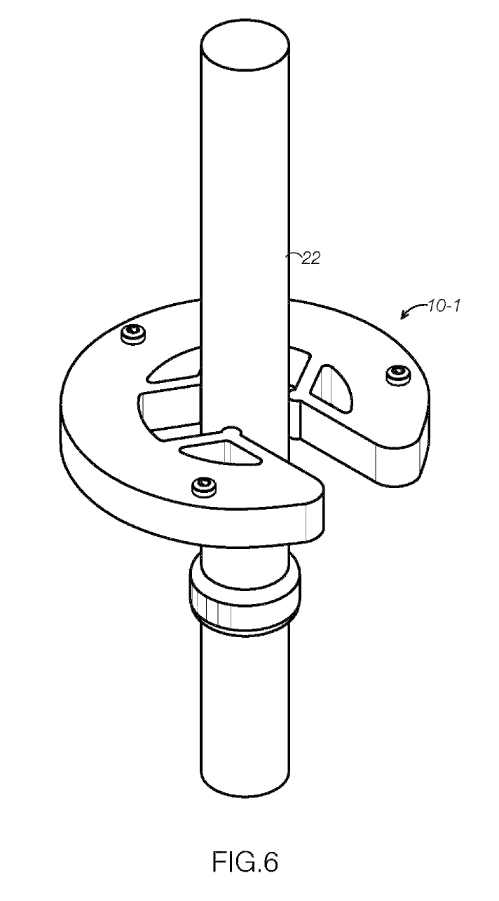

Referring to FIGS. 1 through 6, a swash leveling tool 10, 10-1 may clip onto a main shaft 22, under a swash plate 26 of a helicopter 24, as shown in FIG. 5. The swash leveling tool 10, 10-1 of the present invention provides a stable level reference for leveling the swash plate 26. In some embodiments, the swash leveling tool 10, 10-1 can include a plurality of main shaft contact points 14 spaced apart for the main shaft 22 to fit between the main shaft contact points 14. The swash leveling tool 10, 10-1 can be slid onto the main shaft 22 through a slot 12 cut therein. In some embodiments, one or more main shaft contact points 14 can protrude into the slot to permit the swash leveling tool 10, 10-1 to snap in place on the main shaft 22.

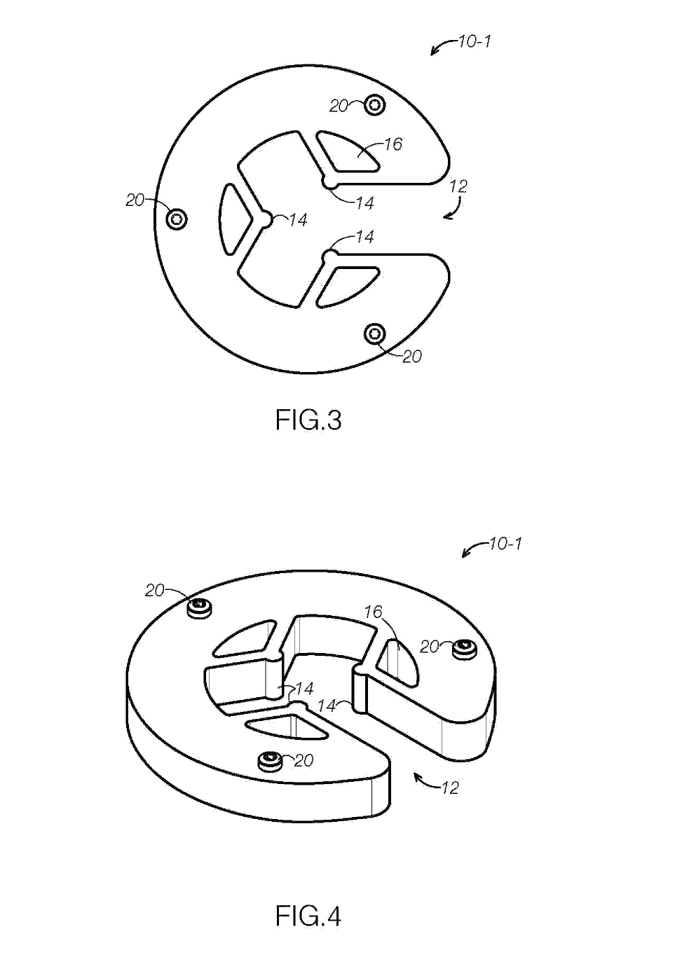

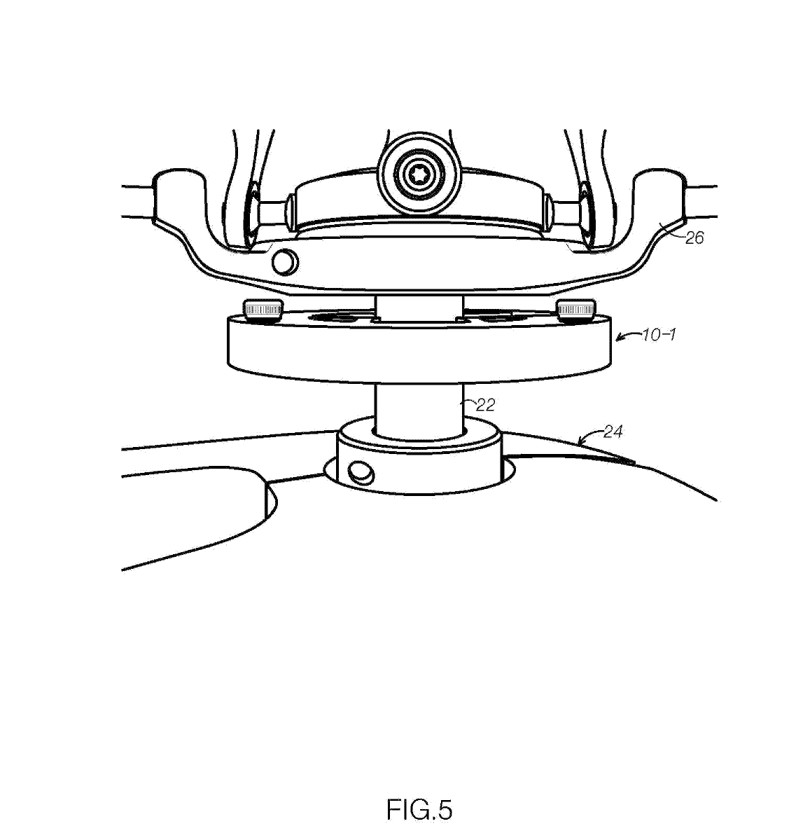

The swash leveling tool 10, 10-1 can be formed with three main shaft contact points 14 protruding into a hole in a central region of the swash leveling tool 10, 10-1. A plurality of openings 16 can be disposed through the swash leveling tool 10, 10-1 to permit axial flexibility to allow the swash leveling tool 10, 10-1 to snap in place on the main shaft 22. Depending on the size of the swash leveling tool 10, 10-1, different sizes and shapes of the slot 12 and the openings 16 can be provided. For example, FIGS. 1 and 2 show swash leveling tool 10 having a first design of the slot 12 (which may be useful in, for example, a swash leveling tool for a 3.5 mm shaft), while FIGS. 3 and 4 show a swash leveling tool 10-1 having a second design of the slot 12 (which may be useful in, for example, a swash leveling tool for shaft diameters that are larger than 3.5 mm).

The swash leveling tool 10, 10-1 of the present invention may include a plurality of reference points 20 protruding from one side of the tool. The reference points 20 can be disposed in holes 18 formed in the tool. The reference points 20 may help with the leveling process. In some embodiments, there may be three reference points 20, disposed at about 120 degrees apart from each other, on the tool, as shown in FIGS. 3 through 6. The reference points 20 may be made from the same or different material from the tool itself. In some embodiments, the reference points may be metal, such as steel, aluminum or the like. In some embodiments, the reference points may threadably engage into the body of the tool, allowing the user to use the tool with or without the reference points.

While the Figures (see FIGS. 1-6, for example) show the swash leveling tool having three points of contact with the main shaft, with a particular cut out design, the swash leveling tool may be of any shape and design, for example, having more or less contact points with the main shaft. So long as the swash leveling tool may fit onto the main shaft to provide a reference plane normal to the main shaft, various sizes and shapes of swash leveling tools are contemplated within the scope of the present invention. Typically, the swash leveling tool will have contact points to allow the tool to clip onto and be removed from the main shaft by hand or through the use of simple hand tools (such as pliers).

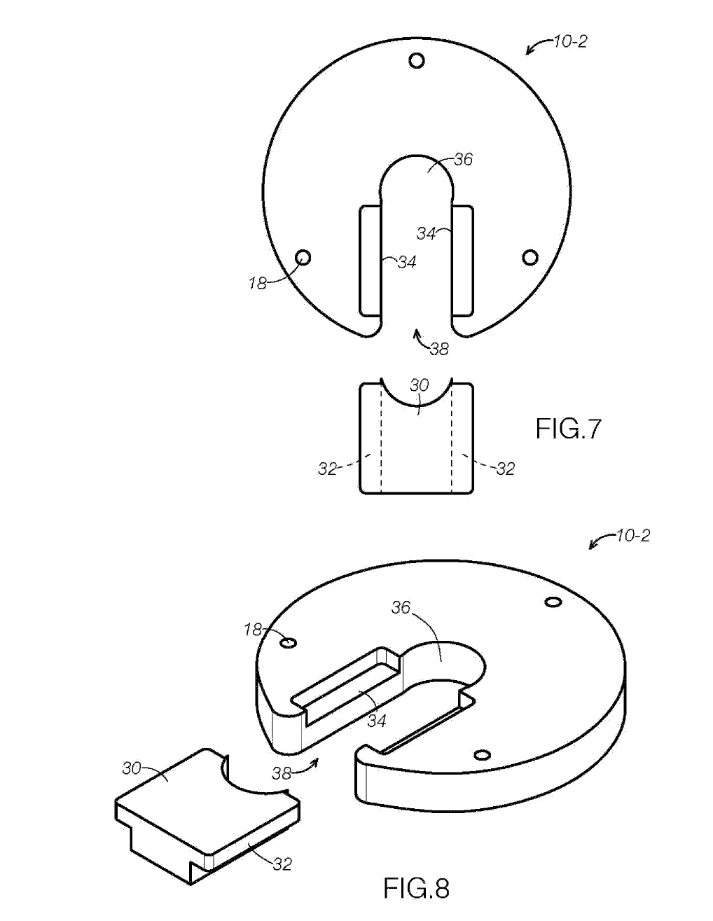

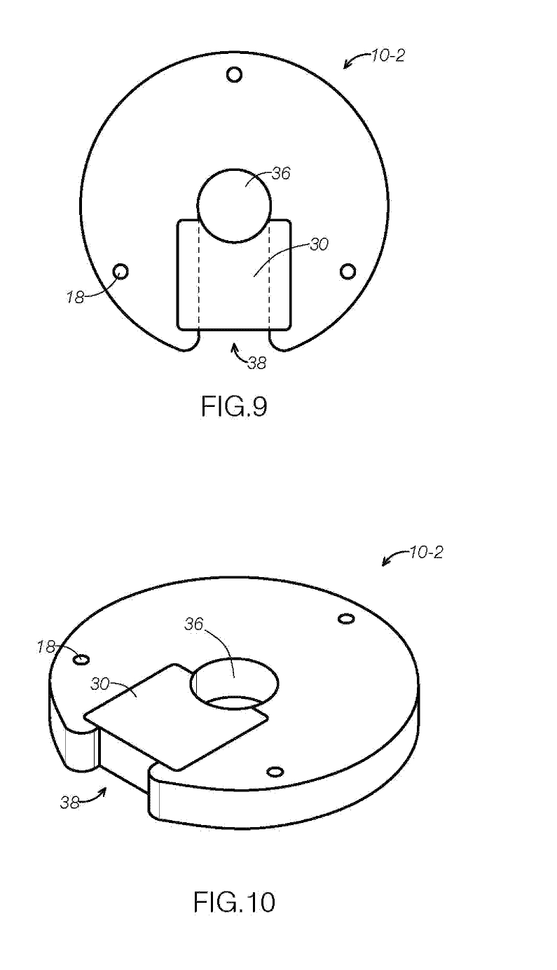

Referring now to FIGS. 7 through 10, a swash leveling tool 10-2 can be designed without contact points 14, as described above with reference to FIGS. 1 through 6, but, instead, with a central circular cutout 36 that communicates with the outside of the swash leveling tool 10-2 through a slot 38. The slot 38 can have a width that is the same as the diameter of the cutout 36, which itself is the same diameter as the main shaft 22 on which the swash leveling tool 10-2 is to be used. A cover 30 can then fit into the slot 38. The cover 30 can have an angled edge matching the arc of the cutout 36 and operable to rest along the main shaft 22 when the swash leveling tool 10-2 is in place on the main shaft 22. The cover 30 can have a sloped side 32 that fits into slopes 34 on sides of the slot 38 to help retain the cover 30 in the slot 38 when in use.

Similar to the swash leveling tools 10, 10-1 described above, the swash leveling tool 10-2 can include a plurality of holes 18 for placement of reference points 20 as may be desired. Like the above described swash leveling tools 10, 10-1, the reference points in the swash leveling tool 10-2 can be formed integrally with the body of the tool of may be a separate member to be added onto the body of the tool.

The swash leveling tool 10, 10-1, 10-2 may be made from various materials. For example, the swash leveling tool may be made from plastic, such as Lexan®, using a computer numerically controlled (CNC) routing mill. Because flex is not required to snap the swash leveling tool 10-2 in place on the main shaft, the swash leveling tool 10-2 can be made from a greater selection of materials, including metals, plastic, composite, or the like. When the tool is made according to this process, the reference points 20 may be later installed on one surface of the tool. Other processes may be used to make the swash leveling tool. For example, the tool may be made from injection molding. In this embodiment, the reference points may be made integral with the tool.

The swash leveling tool 10, 10-1, 10-2 of the present invention may be made to fit various sized main shafts 22. Typical shaft sizes include 3.5 mm and 4-16 mm. Of course, the swash leveling tool of the present invention may be adapted to fit any diameter shaft. The thickness of the swash leveling tool may be any desired thickness, provided that sufficient thickness is available to provide an inside surface to retain the tool against the main shaft, providing the level reference plane. The thickness may be, for example, between about 1 mm and about 6 mm.

It should be understood, of course, that the foregoing relates to exemplary embodiments of the invention and that modifications may be made without departing from the spirit and scope of the invention as set forth in the following claims.

What is claimed is:

1. A swash leveling tool comprising:
a member having an opening to removably retain a main shaft of a radio controlled helicopter therein; and
a reference plane on the member providing a surface normal to the main shaft for leveling a swash of the helicopter, wherein
the member can be attached to and removed from the main shaft without removal of a head from the helicopter.

2. The swash leveling tool of claim 1, further comprising a plurality of holes formed through the member, the plurality of holes equally spaced apart proximate to an outer perimeter of the member.

3. The swash leveling tool of claim 1, further comprising reference points extending from one side of the member.

4. The swash leveling tool of claim 2, further comprising reference points removably attachable in the holes of the member.

5. The swash leveling tool of claim 1, further comprising a plurality of contact points disposed about a central region of the member, wherein the main shaft snaps in place between the plurality of contact points.

6. The swash leveling tool of claim 1, further comprising a central hole for receiving the main shaft therein and a slot communicating the central hole with an exterior of the member.

7. The swash leveling tool of claim 6, wherein the slot has a width equal to a diameter of the main shaft and the central hole has a diameter equal to the diameter of the main shaft.

8. The swash leveling tool of claim 6, further comprising a cover fitting over the slot.

9. The swash leveling tool of claim 8, wherein the cover has angled sides mating with angled sides of the slot.

10. A swash leveling tool comprising:
a member having an opening to removably retain a main shaft of a radio controlled helicopter therein;
a reference plane on the member providing a surface normal to the main shaft for leveling a swash of the helicopter; and
a plurality of contact points disposed about a central region of the member, wherein the main shaft snaps in place between the plurality of contact points, wherein
at least one of the plurality of contact points protruding into the opening; and
the member can be attached to and removed from the main shaft without removal of a head from the helicopter.

11. The swash leveling tool of claim 10, further comprising a plurality of holes formed through the member, the plurality of holes equally spaced apart proximate to an outer perimeter of the member.

12. The swash leveling tool of claim 10, further comprising reference points extending from one side of the member.

13. The swash leveling tool of claim 11, further comprising reference points removably attachable in the holes of the member.

14. A swash leveling tool comprising:
a member having a central hole and for receiving a main shaft of a radio controlled helicopter therein and a slot communicating the central hole with an exterior of the member;
a cover removably fitting over the slot;
a reference plane on the member providing a surface normal to the main shaft for leveling a swash of the helicopter, wherein
the member can be attached to and removed from the main shaft without removal of a head from the helicopter;
the slot has a width equal to a diameter of the main shaft and the central hole has a diameter equal to the diameter of the main shaft; and
the cover has angled sides mating with angled sides of the slot.

15. The swash leveling tool of claim 14, further comprising a plurality of holes formed through the member, the plurality of holes equally spaced apart proximate to an outer perimeter of the member.

16. The swash leveling tool of claim 14, further comprising reference points extending from one side of the member.

17. The swash leveling tool of claim 15, further comprising reference points removably attachable in the holes of the member.
